(19) United States
(12) Patent Application Publication
(10) Pub. No.: US 2014/0064107 A1
(43) Pub. Date: Mar. 6, 2014

(54) METHOD AND SYSTEM FOR FEATURE-BASED ADDRESSING

(71) Applicants: Ignacio Solis, Miami, FL (US); Maurice K. Chu, Burlingame, CA (US)

(72) Inventors: Ignacio Solis, Miami, FL (US); Maurice K. Chu, Burlingame, CA (US)

(73) Assignee: PALO ALTO RESEARCH CENTER INCORPORATED, Palo Alto, CA (US)

(21) Appl. No.: 13/597,157

(22) Filed: Aug. 28, 2012

(51) Int. Cl. H04L 12/16; H04W 24/00

(52) U.S. Cl. 370/252; 370/259

(57) ABSTRACT

One embodiment of the present invention provides a system for computing an address for communicating with a partner. During operation, the system collects data that represents one or more features of a subject of interest to the partner. The system then extracts the one or more features of the subject from the collected data by performing computations with the collected data. Subsequently, the system computes an address for communicating with the partner based on the extracted one or more features.

### BACKGROUND

1. Field

This disclosure is generally related to computing an address for communications. More specifically, this disclosure is related to a method and system for extracting a subject's features from its content and computing an address for communication with a partner based on the extracted features.

2. Related Art

In many situations, a person may want to communicate with a partner without having to use the partner's identity, phone number, or some other conventional form of address. For example, emergency personnel such as firefighters, medical personnel, and law enforcement may come together to deal with an urgent matter. There may be communication problems between the emergency workers if they do not know how to reach the right people or identify each other over open communication channels. The workers may not know each other's names, phone numbers, or other information necessary for establishing communications.

One approach is to ask the intended partner for a phone number, name, user identifier, or other communication identifier. The caller may then establish communications with the partner using the communication identifier. Such manual approaches may not be sufficiently effective or reliable if the parties are not within conversational distance of each other. Further, there may be many potential communication partners and it may be difficult to obtain or track numerous communication identifiers in an emergency situation.

### SUMMARY

One embodiment of the present invention provides a system for computing an address for communicating with a partner. During operation, the system collects data that represents one or more features of a subject of interest to the partner. The system then extracts the one or more features of the subject from the collected data by performing computations with the collected data. Subsequently, the system computes an address for communicating with the partner based on the extracted one or more features.

In a variation on this embodiment, the address is a hash value. Furthermore, computing the address involves computing the hash value based on the extracted one or more features, and setting the address as the computed hash value.

In a variation on this embodiment, the address is an IP address. Furthermore, computing the address involves computing the hash value based on the extracted one or more features and looking up the IP address in a distributed hash table with the computed hash value. In addition, the computed hash value corresponds to the extracted one or more features.

In a variation on this embodiment, the address is a description. Furthermore, computing the address involves determining that the address is a description corresponding to the extracted one or more features.

In a variation on this embodiment, the collected data is an image of the subject. In addition, the system extracts one or more features from the image to compute the address for communicating with the partner.

In a variation on this embodiment, the collected data is a sound recording of the subject. In addition, the system extracts voice characteristics from the sound recording and computes an address for the partner based on the extracted voice characteristics.

In a variation on this embodiment, the collected data is a video recording of the subject. In addition, the system extracts visual and/or audio features from the video recording and computes an address for the partner based on the extracted visual and/or audio features.

In a variation on this embodiment, the collected data is at least one of detected motion or detected changes to a magnetic field. The system also determines measurements for the detected motion or the detected changes to the magnetic field and computes an address for the partner based on the determined measurements.

In a variation on this embodiment, the system sends a communication with the computed address to the partner, wherein the identity of the partner is unknown to the user.

In a variation on this embodiment, the address is a name in a content-based network. In addition, the system extracts features from the collected data to compute the name for communicating with the partner in a content-based network.

In a variation on this embodiment, the system monitors a communication medium with the computed address to identify messages of interest to a user. In addition, the system determines that a difference between the computed address and an address associated with a particular message is within a predetermined threshold. The system further receives the particular message from the communication medium and presents the particular message to the user.

In a further variation, the particular message is received from a node forwarding the particular message.

### BRIEF DESCRIPTION OF THE FIGURES

FIG. 1 presents a diagram illustrating a communication environment within which a user computes a feature-based address for facilitating communications, in accordance with an embodiment of the present invention.

FIG. 2 presents a diagram illustrating a feature-based addressing system, in accordance with an embodiment of the present invention.

FIG. 3 presents a flow chart illustrating a process for computing an address to facilitate communications with a partner, in accordance with an embodiment of the present invention.

FIG. 4 presents a flow chart illustrating a process for receiving communications with feature-based addressing, in accordance with an embodiment of the present invention.

FIG. 5 illustrates an exemplary computer system for computing an address to facilitate communications, in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of obtaining an address to communicate with a partner without exchanging addresses by dynamically computing the address based on features extracted from content, such as pictures, audio, video, or other record data. A feature-based addressing system may extract features such as the colors or shapes of facial features from a picture of the partner. The system can dynamically compute an address for the partner using the extracted features. A user can then communicate with the partner using the computed address without requesting a conventional address from the partner.

The system can also extract the partner's voice from a recording to compute the address. Furthermore, the system can extract features related to a subject of mutual interest. For example, a picture of a subject (e.g., a burning house, a radioactive signature, a heat signature from an airplane, a lost dog) can provide sufficient feature detail to compute an address. The user can then communicate with others who also compute a similar address and are interested in discussing the subject. For example, rescuers after a natural disaster may take a picture of a dangerous building and communicate with other rescuers that also have a picture of the same building. Even without exchanging conventional address information (such as phone numbers), the rescuers may inform each other that a building has not been checked for survivors or that the building is dangerous.

An address can be any information that allows for establishing communications between two or more parties. The address can be a description, a fingerprint, a telephone number, a hash value, or a name in a content-based network. An address can also be an identifier that indicates a location in a network, such as an IP address. The system can utilize a description of the extracted features to serve as the address. The address can also be the person's fingerprint. Furthermore, the address can be a telephone number or a portion of a telephone number (e.g., to determine an extension of the other party). The system can also compute a hash value with the extracted features to serve as the address. Furthermore, the system can utilize the hash value and/or description of the extracted features to look up an address in a directory. In some implementations, a distributed hash table and/or a centralized directory can store mappings from the hash value to an address. For example, a distributed hash table can store mappings from each hash value to an IP address, telephone number, fingerprint, or e-mail address. The system can also use the hash values to construct names for content-based networking.

Communication infrastructure can also support feature-based addressing. Nodes or switches in a network can forward messages or connect communications between two or more parties. Intermediate nodes can store messages and forward the messages to destination addresses at a later point in time. For example, a user can receive messages that are stored in intermediate nodes according to an address computed by the user's device. The nodes may also have routing tables for routing messages based on feature-based addressing. In addition, various implementations may also include directory services to facilitate determination of addresses based on a hash value, description, and/or an extracted feature. Third parties may also serve as a proxy and/or store registered addresses to facilitate communication with feature-based addressing.

### Communication Environment

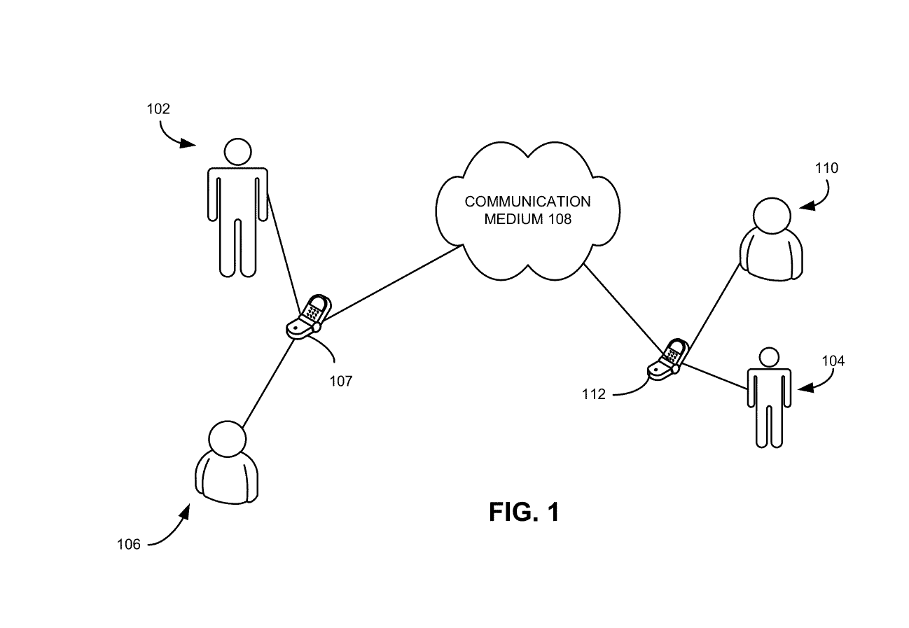

FIG. 1 presents a diagram illustrating a communication environment within which a user computes a feature-based address for facilitating communications, in accordance with an embodiment of the present invention. In FIG. 1, a user 102 wants to communicate with a partner, such as a user 104. User 102 may not know the name, phone number, user identification, Internet Protocol (IP) address, or other identity or addressing information for user 104. However, user 102 may have a picture 106 of user 104 stored on a communication device 107 belonging to user 102. User 102 may have previously taken a picture of user 104 at a business meeting, social function, or emergency situation. It may be inconvenient for user 102 to directly request a name, phone number, e-mail address, or other form of communication address from user 104.

User 102 may desire to communicate with user 104 using a cellular phone, walkie-talkie, satellite phone, or other communication device. User 102 is able to communicate with user 104 using the picture 106 of user 104 stored on communication device 107. One or more components of a feature-based addressing system installed on a mobile device belonging to user 102 extracts the facial characteristics of user 104 from the picture of user 104. The system then computes an address for user 104 based on the extracted features. User 102 may communicate with user 104 through a communication medium 108. Communication medium 108 may be the Internet, the phone network, a walkie-talkie connection, or any infrastructure that allows two or more parties to remotely communicate with each other.

User 104 also has a picture 110 on a communication device 112. Picture 110 may depict facial features of user 104. Communication device 112 also has components of a feature-based addressing system installed. The system extracts features of user 104 from picture 110 and computes an address for user 104. Communication device 112 monitors communication medium 108 and receives messages, phone calls, or other communications that are designated for user 104.

Communication device 112 detects communications designated for user 104 by comparing the address associated with each communication with the address computed from picture 110. If the difference between the addresses is less than a predetermined threshold, then communication device 112 presents the communication to user 104. For example, the system may compare the description of the features extracted from picture 110 with the description associated with each message. The system receives and presents messages to user 104 if the difference between the message's address description and the computed address description is less than the predetermined threshold. The system can compare descriptions based on factors such as colors, categories of objects, and/or measurements of objects. In some implementations, the description may be extracted metadata associated with record data.

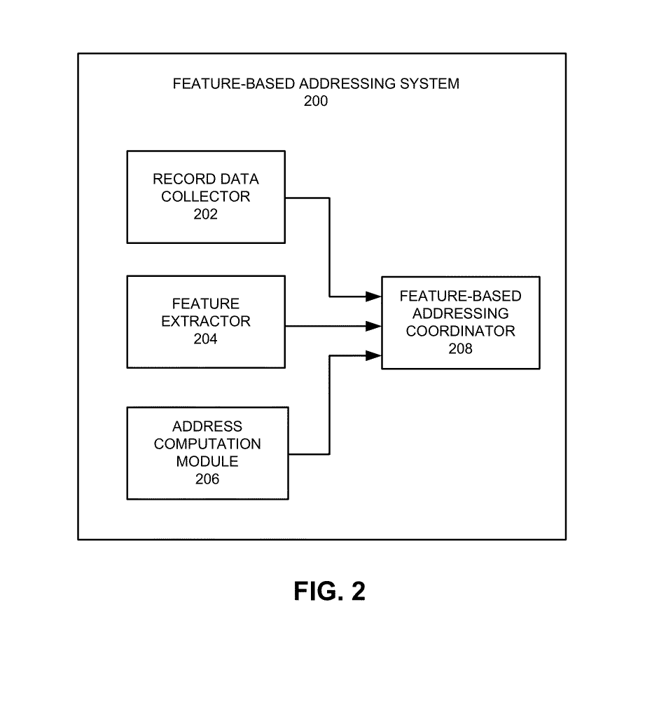

The system can also hash data representing the extracted feature to compute a hash value as the address. The communication devices for user 102 and user 104 may both compute hash values based on pictures of user 104, and each hash value serves as an address for user 104. The system may also map the hash value to an IP address or some other structured address in a distributed hash table. The system may perform a hash table lookup to determine the IP address or other structured address for communication. FIG. 2 discusses the details of a feature-based addressing system in greater detail.

Although the illustrated example discussed with respect to FIG. 1 involves computing the address using a picture of user 104, the system may also compute the address using a sound recording, a video, a document, accelerometer recording, magnetometer recording, or other record data with information regarding different subjects. For example, communication device 104 may store the voices of previous callers, and user 104 may select a voice to compute an address and open up a communication channel. Note that the identity of the partner (e.g., user 104) can also be unknown to the party initiating the communication. Thus, parties previously unknown to each other can initiate communications with each other to discuss a topic.

### Feature-Based Addressing System

FIG. 2 presents a diagram illustrating a feature-based addressing system, in accordance with an embodiment of the present invention. Feature-based addressing system 200 includes a record data collector 202, a feature extractor 204, an address computation module 206, and a feature-based addressing coordinator 208. Each communication device 107, 112 is equipped with components of the feature-based addressing system 200.

Record data collector 202 collects a record of the subject. Such a record is, for example, a video recording, an audio recording, a picture, a document, or some other record data of the subject. For example, record data collector 202 can collect a picture or video record of a burning house when a firefighter photographs or records a video of the burning house. Record data collector 202 can obtain the record data through, for example, a camera, microphone, temperature sensor, accelerometer, magnetometer, or other sensor installed on a communication device. The system can detect and record motion of the mobile device or changes to a magnetic field. The system also determines measurements for detected motion (e.g., movement of the mobile device or relative motions between two mobile devices). Further, the system can detect and record changes to the magnetic field and compute an address for communication with the partner based on the determined measurements. For example, the system can generate an address for communication between mobile devices based on a recorded handshake movement between the mobile devices.

Feature extractor 204 extracts features from the record data. Feature extractor 204 can analyze various image, sound, or other data patterns present in the record data. In example implementations, extracted features can include a sampling of pixel colors from the record data or a sampling of the pixel brightness levels from the record data. For example, feature extractor 204 can analyze pixels from a picture of a face. The selected pixel samples may have a brightness pattern. Feature extractor 204 can also extract voice samples from record data. For example, feature extractor 204 can generate a sound spectrum for a voice recording and analyze the sound spectrum. Feature extractor can also extract detected motion, heat levels, radioactive measurements, or other data for computing an address.

Address computation module 206 computes an address based on the extracted features. Various embodiments may allow for computing different forms of addresses. The computed address can be, for example, a description of the extracted features or a hash of the extracted features. The computed address can also be a network address determined by looking up the hash value in a lookup table (e.g. distributed hash table or a centralized directory). The address can be generated ad hoc for discussing a particular subject with other interested parties.

Feature-based addressing coordinator 208 coordinates the functions of record data collector 202, feature extractor 204, and address computation module 206. Feature-based addressing coordinator 208 invokes record data collector 202 to collect the record data. Feature-based addressing coordinator 208 then invokes feature extractor 204 to extract features from the record data. Feature-based addressing coordinator 208 also invokes address computation module 206 to compute the address based on the extracted features. Feature-based addressing coordinator 208 provides the computed address to a communication system to establish communications and/or send and receive messages.

### Computing an Address for Communication

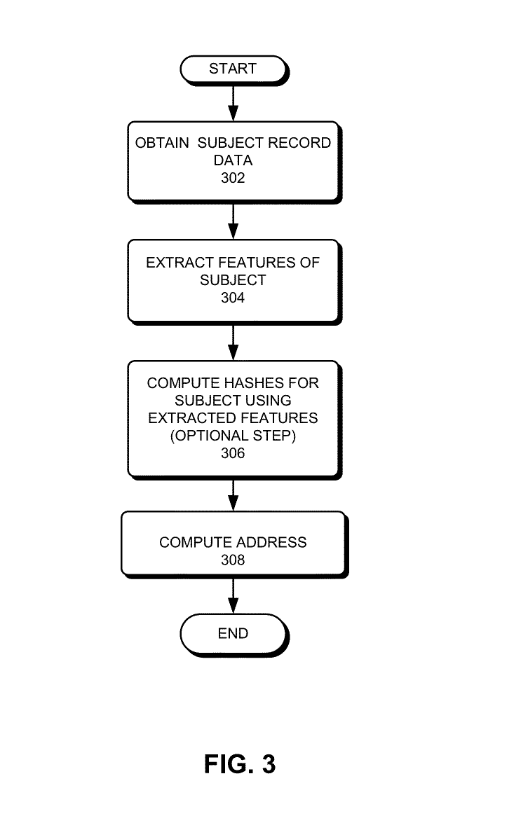

FIG. 3 presents a flow chart illustrating a process for computing an address to facilitate communications with a partner, in accordance with an embodiment of the present invention. During operation, the feature-based addressing system obtains a sample record data for the subject (operation 302). The record data can be generated from any kind of analog signal. The system may obtain the record data through a camera, video recorder, microphone, heat sensor, or some other sensor. The record data can be, for example, audio, video, pictures, documents, or other data. A user can also download record data (e.g., a picture or voice recording) of a subject or a potential partner to extract features from the picture.

The system extracts features of the subject from the record data after obtaining the record data (operation 304). The system can compute hashes for the subject using the extracted features (operation 306). For example, the system can compute a voice signature based on a voice recording. In some embodiments, the system computes multiple hashes to address multiple sets of communication receiving users. For example, the system may compute a first hash to address all receiving users with similar hair color. Then, the system may compute a second hash to address all receiving users with the same gender.

The system then computes the address for communication with a partner (operation 308). For example, the system can compute the address by applying a hash function to the voice recording to create a voice signature. As another example, the system can compute an address based on magnetometer data indicating a handshake movement between two mobile devices. Note that the address space can be limited to correspond to a specific group of people. This increases the probability of properly establishing communications with an appropriate partner. For example, a large organization can take pictures of all the employees, and the system can compute addresses from only the employees' pictures.

Note that a hash is not limited to a conventional mathematical hash (e.g., mapping from input data to a checksum or other mathematical value). In some embodiments, a hash is a generic descriptor computed based on the extracted features that can be used to compare objects for similarity. For example, a user may select a picture of a male communication recipient, and the user may choose to compute a hash to address all users matching the gender indicated in the picture. An originating user (e.g., user 102) can also choose to compute a hash to address all receiving users (e.g., user 104) with hair color that is within a threshold difference of the hair color indicated in the picture. In both cases, computing the addresses can involve generating generic descriptor hashes.

Receiving Communications with Feature-Based Addressing

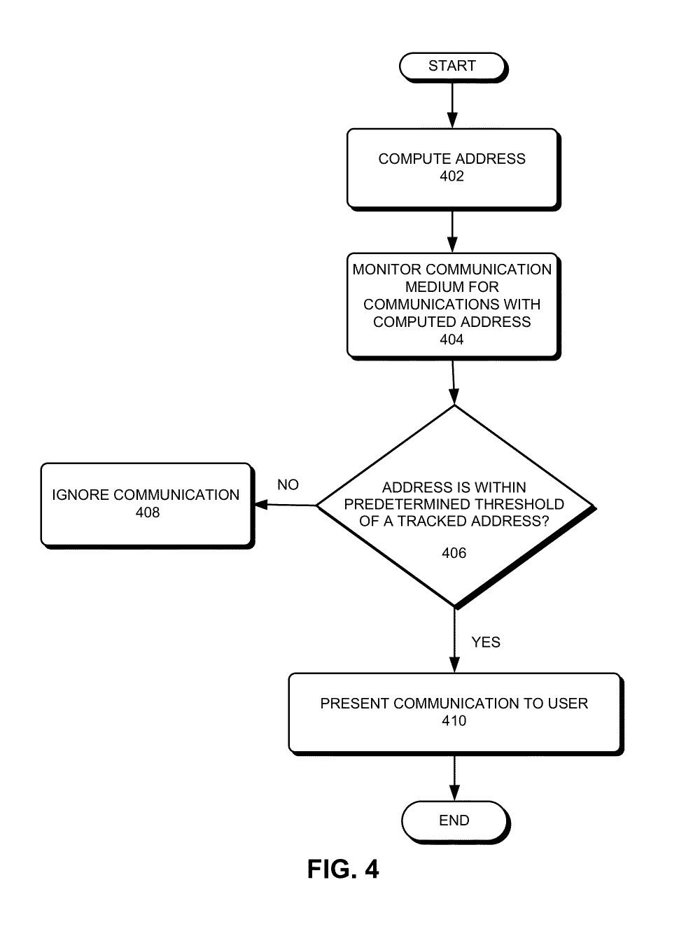

FIG. 4 presents a flow chart illustrating a process for receiving communications with feature-based addressing, in accordance with an embodiment of the present invention. During operation, the feature-based addressing system computes an address for a user (e.g., a user expecting to receive communications), such as user 104 from FIG. 1 (operation 402). The system computes an address as described with respect to FIG. 3. This user can set the user's communication device to monitor a communication medium for communications intended for the user.

The system monitors the communication medium for communications associated with the computed address (operation 404). The system examines the address associated with each communication. The system determines whether the examined address is within a pre-determined threshold distance associated with a tracked address (operation 406). In some implementations, to measure the differences between two addresses, the system can compute a vector distance between the two addresses. The system can also require that hash values are exact matches.

In another example, the system may require that the differences between the receiving user's fingerprint and the originating party's supplied fingerprint are within a predetermined threshold difference value. The fingerprint associated with a requested communication channel may be computed by or otherwise provided by the communication originating party. The system may compare the fingerprint for user 104 with a fingerprint associated with a request to open the communication channel to determine that the communication channel request is intended for user 104. Although the examples illustrated discuss comparing differences between addresses with respect to fingerprints, embodiments of the invention can also include comparing the differences between any forms of addresses. Furthermore, the communication device can compute and track multiple addresses for the user based on various record data.

If the communication's associated address is not within a predetermined threshold of any tracked address, the system ignores the communication (operation 408). If the communication's associated address is within the predetermined threshold of a tracked address, the system presents the communication to the user (operation 410). For example, a walkie-talkie can output received sound communications associated with a tracked address through speakers to the user. As another example, a mobile phone may connect the user to the caller or may receive a text or voice message for the user with the tracked address.

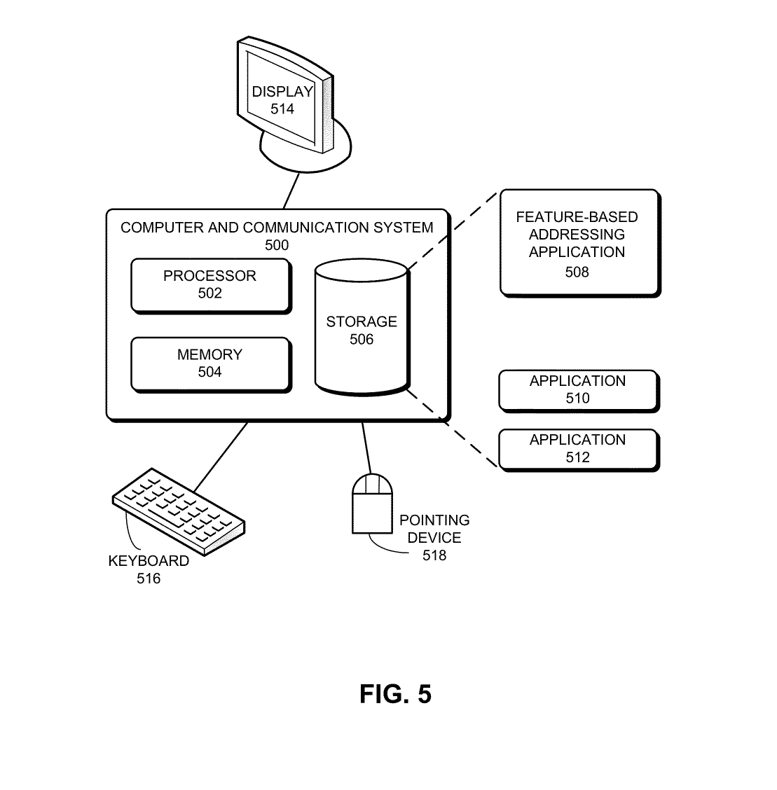

FIG. 5 illustrates an exemplary computer system for computing an address to facilitate communications, in accordance with one embodiment of the present invention. In one embodiment, a computer and communication system 500 includes a processor 502, a memory 504, and a storage device 506. Storage device 506 stores a feature-based addressing system application 508, as well as other applications, such as applications 510 and 512. During operation, feature-based addressing system application 508 is loaded from storage device 506 into memory 504 and then executed by processor 502. While executing the program, processor 502 performs the aforementioned functions. Computer and communication system 500 is coupled to an optional display 514, keyboard 516, and pointing device 518. Computer and communication system 500 may be any form of computer system, including desktop personal computers, tablets, mobile phones, wall-mounted displays, or other electronic communication devices.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for computing an address for communicating with a partner, the method comprising:
collecting data that represents one or more features of a subject of interest to the partner;
extracting the one or more features of the subject from the collected data by performing computations with the collected data; and
computing an address for communicating with the partner based on the extracted one or more features.

2. The method of claim 1, wherein the address is a hash value and computing the address further involves:
computing the hash value based on the extracted one or more features, and
setting the address as the computed hash value.

3. The method of claim 1, wherein the address is an IP address and computing the address further involves:
computing the hash value based on the extracted one or more features; and
looking up the IP address in a distributed hash table with the computed hash value, wherein the computed hash value corresponds to the extracted one or more features.

4. The method of claim 1, wherein the address is a description and computing the address further involves determining that the address is a description corresponding to the extracted one or more features.

5. The method of claim 1, wherein the collected data is an image of the subject and wherein the method further comprises extracting one or more features from the image to compute the address for communicating with the partner.

6. The method of claim 1, wherein the collected data is a sound recording of the subject, and wherein the method further comprises:
extracting voice characteristics from the sound recording; and
computing an address for the partner based on the extracted voice characteristics.

7. The method of claim 1, wherein the collected data is a video recording of the subject, and wherein the method further comprises:
extracting visual and/or audio features from the video recording; and
computing an address for the partner based on the extracted visual and/or audio features.

8. The method of claim 1, wherein the collected data is at least one of detected motion or detected changes to a magnetic field, and wherein the method further comprises:
determining measurements for the detected motion or the detected changes to the magnetic field; and computing an address for the partner based on the determined measurements.

9. The method of claim 1, further comprising sending a communication with the computed address to the partner, wherein the identity of the partner is unknown to the user.

10. The method of claim 1, wherein the address is a name in a content-based network; and wherein the method further comprises extracting features from the collected data to compute the name for communicating with the partner in a content-based network.

11. The method of claim 1, further comprising:
monitoring a communication medium with the computed address to identify messages of interest to a user;
determining that a difference between the computed address and an address associated with a particular message is within a predetermined threshold;
receiving the particular message from the communication medium; and
presenting the particular message to the user.

12. The method of claim 11, wherein the particular message is received from a node forwarding the particular message.

13. A computing system for computing an address for communicating with a partner, the system comprising:
one or more processors,
a computer-readable medium coupled to the one or more processors having instructions stored thereon that, when executed by the one or more processors, cause the one or more processors to perform operations comprising:
collecting data that represents one or more features of a subject of interest to the partner;
extracting the one or more features of the subject from the collected data by performing computations with the collected data; and
computing an address for communicating with the partner based on the extracted one or more features.

14. The computing system of claim 13, wherein the address is a hash value and wherein computing the address further involves:
computing the hash value based on the extracted one or more features, and
setting the address as the computed hash value.

15. The computing system of claim 13, wherein the address is an IP address and wherein computing the address further involves:
computing the hash value based on the extracted one or more features; and
looking up the IP address in a distributed hash table with the computed hash value, wherein the computed hash value corresponds to the extracted one or more features.

16. The computing system of claim 13, wherein the address is a description and computing the address further involves determining that the address is a description corresponding to the extracted one or more features.

17. The computing system of claim 13, wherein the collected data is an image of the subject and wherein the computer-readable storage medium stores additional instructions that, when executed, cause the one or more processors to perform additional steps comprising:
extracting one or more features from the image to compute the address for communicating with the partner.

18. The computing system of claim 13, wherein the collected data is a sound recording of the subject, and wherein the computer-readable storage medium stores additional instructions that, when executed, cause the one or more processors to perform additional steps comprising:
extracting voice characteristics from the sound recording; and
computing an address for the partner based on the extracted voice characteristics.

19. The computing system of claim 13, wherein the collected data is a video recording of the subject, and wherein the computer-readable storage medium stores additional instructions that, when executed, cause the one or more processors to perform additional steps comprising:
extracting visual and/or audio features from the video recording; and
computing an address for the partner based on the extracted visual and/or audio features.

20. The computing system of claim 13, wherein the collected data is at least one of detected motion or detected changes to a magnetic field, and wherein the computer-readable storage medium stores additional instructions that, when executed, cause the one or more processors to perform additional steps comprising:
determining measurements for the detected motion or the detected changes to the magnetic field; and
computing an address for the partner based on the determined measurements.

21. The computing system of claim 13, wherein the computer-readable storage medium stores additional instructions that, when executed, cause the one or more processors to perform additional steps comprising:
sending a communication with the computed address to the partner, wherein the identity of the partner is unknown to the user.

22. The computing system of claim 13, wherein the address is a name in a content-based network; and wherein the computer-readable storage medium stores additional instructions that, when executed, cause the one or more processors to perform additional steps comprising:
extracting features from the collected data to compute the name for communicating with the partner in a content-based network.

23. The computing system of claim 13, wherein the computer-readable storage medium stores additional instructions that, when executed, cause the one or more processors to perform additional steps comprising:
monitoring a communication medium with the computed address to identify messages of interest to a user;
determining that a difference between the computed address and an address associated with a particular message is within a predetermined threshold;
receiving the particular message from the communication medium; and
presenting the particular message to the user.

24. The computing system of claim 23, wherein the particular message is received from a node forwarding the particular message.

25. A computer-readable storage medium storing instructions that when executed by a computer cause the computer to perform a method for computing an address for communicating with a partner, the method comprising:
collecting data that represents one or more features of a subject of interest to the partner;
extracting the one or more features of the subject from the collected data by performing computations with the collected data; and
computing an address for communicating with the partner based on the extracted one or more features.
